(19) United States
(12) Patent Application Publication
(10) Pub. No.: US 2011/0191584 A1
(43) Pub. Date: Aug. 4, 2011

(54) System and Method for Computationally Private Information Retrieval

(76) Inventors: Jonathan T. Trostle, Ellicott City, MD (US); Andrew T. Parrish, Lajola, CA (US)

(21) Appl. No.: 12/851,239

(22) Filed: Aug. 5, 2010

Related U.S. Application Data
(60) Provisional application No. 61/232,108, filed on Aug. 7, 2009.

(51) Int. Cl. H04L 9/00

(52) U.S. Cl. 713/165

(57) ABSTRACT

A device is provided for use with a database server having a matrix of data stored therein, wherein the database can transmit a return vector based on the matrix of data. The device includes a communication portion, an encryption portion and a decryption portion. The encryption portion can generate an encrypted request to obtain a portion of the matrix of data, wherein the encrypted request includes a plurality of subqueries. The communication portion can transmit the encrypted request to the database server and can receive the return vector from the database server. One of the subqueries is based on a first random vector and a target vector corresponding to the portion of the matrix of data. One of the subqueries is based on a second random vector. The decryption portion can decrypt the return vector by way of a modulo summation.

In accordance with 35 U.S.C. §120, the present application claims priority from U.S. Provisional Application No. 61/232,108 to Jonathan Trostle, and Andrew Parish, entitled, “a Fast Protocol for Computationally Private Information Retrieval”, filed Aug. 7, 2009, the entire disclosure of which is incorporated herein by reference.

### BACKGROUND

The present invention relates to secure information retrieval from a server database.

A Private Information Retrieval (PIR) protocol allows a server database user, or client, to obtain information from a server database in a manner that prevents the server database from knowing which data was retrieved. Although substantial progress has been made in the discovery of computationally PIR (cPIR) protocols with reduced communication complexity, there has been relatively little work in reducing the computational complexity of cPIR protocols. In particular, some believe that existing cPIR protocols are slower than the trivial FIR protocol (in overall performance). Typically, the server database is modeled as an n-bit string and the user wants to obtain bit i in the string, such that i remains unknown to the server database. More generally, the server database is modeled as a sequence of blocks, and the user will retrieve the ith block, where i remains unknown to the server database. The trivial protocol consists of downloading the entire server database, which clearly preserves privacy. The goal of PIR protocols is to obtain better performance (both computational and communication costs) than the trivial protocol, yet maintain privacy.

There is a wealth of information in a user's database access patterns. In many cases, these patterns give information about a user's or organization's future plans. For example, consider a pharmaceutical corporation's plans for future patent applications and potential server database searches in connection with those plans.

For PIR, privacy of the server database is generally not protected and private information is retrieved from either a public server database or a server database with a group of subscribers. Although users can download the entire server database, this takes too long for a large server database. Thus PIR that protects only the user is desirable in this scenario.

Information-theoretic PIR protocols have been presented where the server database is replicated and the replicas are not allowed to communicate; this work shows that single server database information-theoretic PIR with no leakage does not exist. In general, the security of information-theoretic PIR protocols requires that the replicas not communicate.

Performance results have been presented claiming that all of the existing schemes are slower than the trivial protocol, mainly due to the bottleneck caused by the server database's computational load. Anonymity use has been explored in order to create more efficient cPIR protocols; these protocols depend on both sender anonymity and the noisy curve reconstruction problem.

In view of the foregoing, there is a need for improved techniques for providing PIR.

### BRIEF SUMMARY

In accordance with example embodiments of the present invention, a communication system may provide secure, efficient and cost effective retrieval of information from a database. A user or multiplicity of users may use the communication system to retrieve information from a database in a secure, efficient and cost effective manner.

A device is provided for use with a database server having a matrix of data stored therein, wherein the database can transmit a return vector based on the matrix of data. The device includes a communication portion, an encryption portion and a decryption portion. The encryption portion can generate an encrypted request to obtain a portion of the matrix of data, wherein the encrypted request includes a plurality of subqueries. The communication portion can transmit the encrypted request to the database server and can receive the return vector from the database server. One of the subqueries is based on a first random vector and a target vector corresponding to the portion of the matrix of data. One of the subqueries is based on a second random vector. The decryption portion can decrypt the return vector by way of a modulo summation.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates an example communication system in accordance with aspects of the present invention;

FIG. 2 illustrates an example user processor of FIG. 1, in accordance with aspects of the present invention;

FIG. 3 illustrates an example encryption portion of FIG. 2, in accordance with aspects of the present invention;

FIG. 4 illustrates an example decryption portion of FIG. 2, in accordance with aspects of the present invention;

FIG. 5 illustrates an example database processor of FIG. 1, in accordance with aspects of the present invention;

FIG. 6 illustrates an example encryption portion of FIG. 5, in accordance with aspects of the present invention;

FIGS. 7A-B illustrate an example method for privately retrieving information in accordance with an aspect of the present invention;

FIG. 8 illustrates another example communication system in accordance with aspects of the present invention;

FIG. 9 illustrates another example of encryption portion of FIG. 2, in accordance with aspects of the present invention;

FIG. 10 illustrates another example of decryption portion 211 of FIG. 2, in accordance with aspects of the present invention;

FIG. 11 illustrates another example encryption portion 506 of FIG. 5, in accordance with aspects of the present invention;

FIGS. 12A-C illustrate an example trapdoor group cPIR protocol for privately retrieving information in accordance with an aspect of the present invention;

FIG. 13 presents a table of execution times for a trapdoor group cPIR protocol in accordance with aspects of the present invention; and

FIG. 14 presents a table of execution times for a trapdoor group cPIR protocol in accordance with aspects of the present invention as compared to prior art implementations.

### DETAILED DESCRIPTION

Aspects of the present invention provides for secure, efficient and cost effective retrieval of information from a database. Aspects of the present invention are generally drawn to two types of cPIR protocols: 1) an anonymity based cPIR protocol; and 2) a trapdoor group cPIR protocol.

With the anonymity based cPIR protocol, given sender anonymity, a user will split their query into a small number of subqueries and mix them with other subqueries before sending to the server database. These subqueries will be mixed with other user cPIR subqueries. By mixing the subqueries, the adversary must guess the right subqueries to add back together to obtain the original query. This problem becomes difficult as the number of users and queries increases. As the number of users grows, the amount of noise added by each user (the number of subqueries w that each query will be split into) can be reduced. An overview of the anonymity based cPIR protocol (for the bit vector case) will now be described.

First, the server database is viewed as n^{1/2} by n^{1/2} bit matrix, with n total entries. For example, each row could be viewed as a block of data (set of bits).

Second, the user will obtain a single block by sending a PIR query. The user creates a bit vector B with a one bit in the position corresponding to the row the user will query, and zero bits in the other positions. Of course, sending this vector would not protect the user's privacy. Therefore, the user adds a uniformly generated bit vector U to B to obtain the bit vector R. R will be sent to the server database as a subquery along with other “noise” subqueries. These subqueries will be a set of vectors as will be explained in more detail below.

Third, the server database receives the subqueries. Of course, if these are the only subqueries received by the server database, it can sum them and obtain B. Security is obtained via sender anonymity and assuming that many subqueries are sent by the original user and other users corresponding to many queries. The subqueries are all uniformly distributed and indistinguishable to the server database. Thus it becomes computationally infeasible for the server database to pick the right queries to add together to obtain B.

Fourth, for each subquery, the server database will sum the elements (mod 2) in each column corresponding to the one bits in the received subquery. The resulting bit vector is returned to the user.

Fifth, the user will take the correct set of returned bit vectors and sum them (mod 2) in order to obtain the desired row of data from the server database.

With the trapdoor group cPIR protocol, a group order, m, is unknown to the server database whereas the user uses this value to compute discrete logs to obtain the results of the PIR query. The natural generalization is a trapdoor group. In a trapdoor group, an inversion problem such as computing discrete logarithms may be computed efficiently assuming knowledge of the trapdoor. Without the trapdoor, solving the inversion problem is computationally hard.

A more detailed description may be drawn to two types of cPIR protocols in accordance with aspects of the present invention will now be described.

In accordance with aspects of the present invention, a user processor or multiplicity of user processors may be arranged to communicate with a server database via an anonymizing communications network, i.e., a communications network that keeps the identity of the users anonymous with respect to other users and the server database. Non-limiting examples of communications networks which may be supported include Ethernet, optical fiber, Local Area Network (LAN), Wireless LAN (WLAN), Internet, cable, cellular, satellite and power line.

In accordance with aspects of the present invention, a user processors may include devices for interaction with users. Non-limiting examples of devices which set top boxes may provide for interacting with users include Graphical User Interfaces (GUIs), monitors, televisions, keyboards, keypads, touch-screens, trackballs, pointing devices, mouses, audio speakers, facsimiles, printers and scanners.

In accordance with aspects of the present invention, a user may request data from a server database via interface with user processor. User processor may encrypt user's request for data. User processor may communicate encrypted user request to anonymizing communications network. Anonymizing communications network may communicate encrypted user request to a server database processor. Server database processor may perform retrieval of information from server database in a manner such that the server database and external entities may not be able to discern the information the user is seeking to retrieve. Server database processor may communicate the results of the server database query as a return vector to anonymizing communications network. Anonymizing communications network may communicate the return vector to user processor. User processor may decrypt return vector communicated from server database processor. Decrypted information may be communicated by user processor to user.

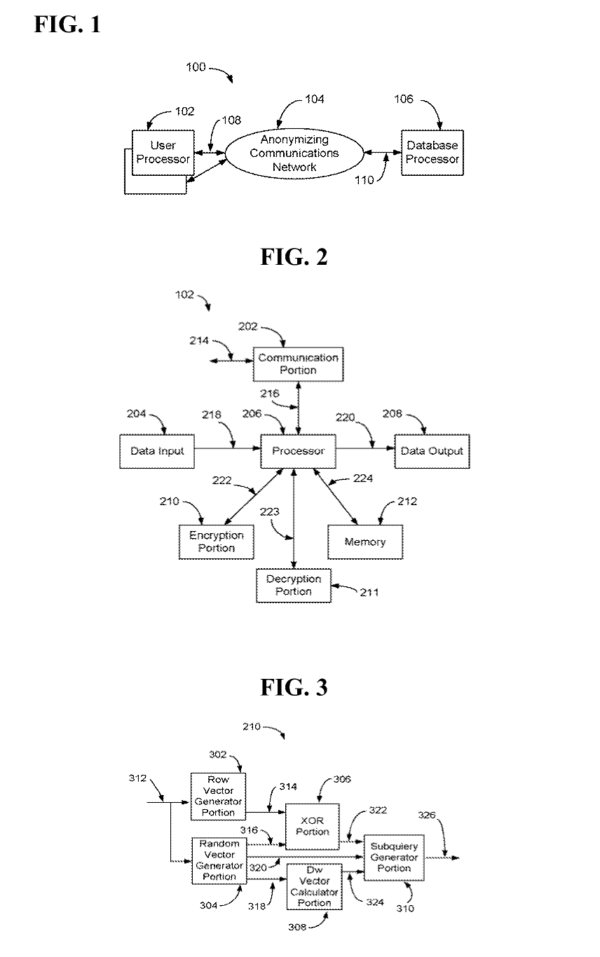

An anonymity based cPIR protocol in accordance with aspects of the present invention will now be described with reference to FIGS. 1-7B.

FIG. 1 illustrates an example communication system 100 in accordance with aspects of the present invention.

As illustrated in the figure, communication system 100 includes a multiplicity of user processors, with a sampling denoted as a user processor 102, an anonymizing communications network 104 and a database processor 106.

Anonymizing communications network 104 may communicate bi-directionally with user processor 102 via a communication channel 108 and with database processor 106 via a communication channel 110. Communication channel 108 and 110 may be wired or wireless signals. Although, each of communication channel 108 and 110 are illustrated as distinct communication channels, they all may share a predetermined frequency band within a wireless medium. Signals typically embody computer-readable instructions, data structures, program modules, or other data in a modulated data signal such as a carrier wave or other transport mechanism and include any information-delivery media. Non-limiting examples of communications media, which may carry signals, include wired media, such as wired networks and direct-wired connections, and wireless media such as acoustic, radio, infrared, and other wireless media. The term “computer-readable media” as used herein includes both storage media and communications media.

User processor 102 may interface with a user for communicating information to/from external entities via anonymizing communications network 104 and to perform other media and computing functions. User processor 102 may communicate information in such a way as to prevent compromise of the data communicate to/from user processor 102. Anonymizing communications network 104 may communicate information from various user processors and other network and network terminal devices. Anonymizing communications network 104 may communicate with a plurality of communication capable devices and as a result of the communication interaction with the large number of communication devices, the information received by a communication device from anonymizing communications network 104 may be anonymous, i.e. devices may not be able to discern the origination of an information request. Non-limiting examples of networks which anonymizing communications network 104 may communicate with include Ethernet, optical fiber, Local Area Network (LAN), Wireless LAN (WLAN), Internet, cable, cellular, satellite and power line. Database processor 106 may store and retrieve information and communicate with external entities via anonymizing communications network 104. Database processor 106 may perform operations in a secure manner in such a way as to prevent compromising the content of the data stored within and communicated to/from database processor 106. In particular, database processor 106 may receive an encrypted assembly of vectors and process the vectors to generate an encrypted assembly of return vectors for transmission to a user in such a way that an external entity (or entities) cannot detect which data is actually being requested by user.

Communication system 100 may allow a user (not shown) to receive information from database processor 106 in such a way as to prevent other entities and devices from detecting which data the user is actually interested in receiving.

FIG. 2 illustrates an example user processor 102 of FIG. 1, in accordance with aspects of the present invention.

As illustrated in FIG. 2, user processor 102 includes a communication portion 202, a data input 204, a processor 206, a data output 208, an encryption portion 210, a decryption portion 211 and a memory 212. All of the elements of communication portion 202, data input 204, processor 206, data output 208, encryption portion 210, decryption portion 211 and memory 212 are illustrated as individual devices. However, in some embodiments, at least two of communication portion 202, data input 204, processor 206, data output 208, encryption portion 210, decryption portion 211 and memory 212 may be combined as a unitary device. Further, in some embodiments, at least one of communication portion 202, data input 204, processor 206, data output 208, encryption portion 210, decryption portion 211 and memory 212 may be implemented as computer-readable media for carrying or having computer-executable instructions or data structures stored thereon. Such computer-readable media can be any available media that can be accessed by a general purpose or special purpose computer. Non-limiting examples of computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Communication portion 202 may bi-directionally communicate with external entities (not shown) via a communication channel 214 and with processor 206 via a communication channel 216. Processor 206 may receive information from data input 204 via a communication channel 218, communicate bi-directionally with encryption portion 210 via a communication channel 222, communicate bi-directionally with decryption portion 211 via a communication channel 223 and communicate bi-directionally with memory 212 via a communication channel 224. Data output 208 may receive information from processor 206 via a communication channel 220 and to transmit information to a user (not shown). Data input 204 may receive information from user. Communication channel 214, 216, 218, 220, 222, 223 and 224 may be wired or wireless signals. Although, each of communication channel 214, 216, 218, 220, 222, 223 and 224 are illustrated as distinct communication channels, they all may share a predetermined frequency band within a wireless medium.

User processor 102 may present information to a user via data output 208. Non-limiting examples of data output 208 include Graphical User Interface (GUI), computer monitor, computer display, gaming system display, television, display of mobile device, audio speaker and printer.

User processor 102 may receive information from a user via data input 204. Non-limiting examples of data input 204 include mouse, trackball, keyboard, keypad, touch-screen, pointing device and scanner. User processor 102 may communicate with external devices via communication portion 202. Non-limiting examples of networks with which communication portion 202 may communicate include Ethernet, optical fiber, Local Area Network (LAN), Wireless LAN (WLAN), Internet, cable, cellular, satellite and power line.

Processor 206 may execute operational codes retrieved from memory 212 and to store and retrieve information to/from memory 212. Non-limiting examples of memory include Random Access Memory (RAM), Dynamic Random Access Memory (DRAM), Read-Only Memory (ROM), Digital Video Disk (DVD), Compact Disk Read-Only Memory (CDROM), Hard Disk (HD) and flash memory. Non-limiting examples of software languages for which operational codes for processor 206 may be compiled and assembled from include “C”, “C++”, “C#” and Java.

Encryption portion 210 may perform encryption of information for transmission via communication portion 202. More specifically, encryption portion 210 may generate an encrypted assembly of vectors for transmission to a database processor for requesting data in such a way that an external entity (or entities) may not detect which data is actually being requested for use.

Decryption portion 211 may perform decryption of information received via communication portion 202. More specifically, decryption portion 211 may decrypt an assembly of return vectors transmitted from a server database in such a way that an external entity (or entities) cannot detect the actually requested data.

In operation, communication portion 202 may receive information via communication channel 214. Communication portion 202 may communicate received information to processor 206 via communication channel 216. Processor 206 may communicate received information to memory 212 via communication channel 224, to encryption portion 210 via communication channel 222 and to decryption portion 211 via communication channel 223.

Encryption portion 210 may encrypt received information. Processor 206 may then operate to receive encrypted information from encryption portion 210 for further processing related to transmission of the information. Decryption portion 211 may decrypt received information. Processor 206 may then operate to receive decrypted information from decryption portion 211 for further processing related to display of information to user. Non-limiting examples of processing for which processor 206 may engage include executing algorithms and communicating information to data output 208 via communication channel 220 for user to view, listen and print.

User presented information by data output 208 may communicate information to be transmitted to external entities. User may present information to be communicated via data input 204. Data input 204 may communicate the information to be transmitted to processor 206 via communication channel 218. Processor 206 may communicate encrypted information to be transmitted to communication portion 202 via communication channel 216. Communication portion 202 may transmit encrypted information externally to user processor 102 via communication channel 214.

User processor 102 may interface with a user for communicating information to/from external entities via a communication network and to perform encryption, decryption and other media and computing functions.

FIG. 3 illustrates an example encryption portion 210 of FIG. 2, in accordance with aspects of the present invention.

As illustrated in FIG. 3, encryption portion 210 includes a row vector generator portion 302, a random vector generator portion 304, a XOR Portion 306, a Dw vector calculator portion 308 and a subquery generator portion 310. All of row vector generator portion 302, random vector generator portion 304, XOR Portion 306, Dw vector calculator portion 308 and subquery generator portion 310 are illustrated as individual devices. However, in some embodiments, at least two of row vector generator portion 302, random vector generator portion 304, XOR Portion 306, Dw vector calculator portion 308 and subquery generator portion 310 may be combined as a unitary device. Further, in some embodiments, at least one of row vector generator portion 302, random vector generator portion 304, XOR Portion 306, Dw vector calculator portion 308 and subquery generator portion 310 may be implemented as computer-readable media for carrying or having computer-executable instructions or data structures stored thereon.

Row vector generator portion 302 and random vector generator portion 304 may receive information provided external to encryption portion 210 via a communication channel 312. XOR portion 306 may receive information from row vector generator portion 302 via a communication channel 314 and from random vector generator portion 304 via a communication channel 316. Dw vector calculator portion 308 may receive information from random vector generator portion 304 via a communication channel 318. Subquery generator portion 310 may receive information from random vector generator portion 304 via a communication channel 320, from XOR portion 306 via a communication channel 322 and from Dw vector calculator portion 308 via a communication channel 324. Furthermore, subquery generator portion 310 may transmit information external to encryption portion 210 via a communication channel 326. Communication channel 312, 314, 316, 318, 320, 322, 324 and 326 may be wired or wireless signals. Although, each of communication channel 312, 314, 316, 318, 320, 322, 324 and 326 are illustrated as distinct communication channels, they all may share a predetermined frequency band within a wireless medium.

Row vector generator portion 302 may generate a target vector based upon a row or record of target data, i.e., data desired to be viewed or used by a user to be communicated from a database located within database processor 106. For example, if a user seeks to obtain data located in the third row or record of the database, then the third element of the vector generated by row vector generator portion 302 would be an integer 1 with all other elements of the vector configured as an integer 0. For example, for a database with four rows or records, if a user is seeking information stored within the third row or record of the database, then row vector generator portion 302 may generate a target vector, a vector as illustrated by B₁={0 0 1 0}.

Random vector generator portion 304 may randomly generate a set of uniform vectors. It should be noted that the terms “random” and “randomly” used herein actually mean “pseudo-random” and “pseudo-randomly” as known to those of skill in the art. For example, there is no known method to generate a true “random number,” but any known system or method may be used to generate a “pseudo-random number.” For example, a set of random uniform vectors may be illustrated by U₁={1 1 0 0}, D₁={0 1 0 0} and D₂={0 0 1 1}.

XOR portion 306 may perform an exclusive-or operation. For example XOR portion 306 may perform an exclusive-or of target vector B₁ and vector D₁ as discussed previously and as illustrated by B₁ ⊕U₁ or {0 0 1 0}⊕{1 1 0 0} and results in vector.

Dw vector calculator portion 308 may generate a vector such that its summation with all Dᵢ vectors is equal to U₁, as illustrated by the equation Σᵢ₌₁^{w} Dᵢ=U. For example, for the previously discussed vectors D₁, D₂ and U₁, Dw may be calculated as {1 0 1 1}.

Subquery generator portion 310 may configure and assemble calculated vectors for transmission to an external entity or entities. For example, subquery generator portion 310 may assemble a vector using the previously discussed target vector B, vector U and vector D as B₁ ⊕U₁, D₁, D₂ and Dw.

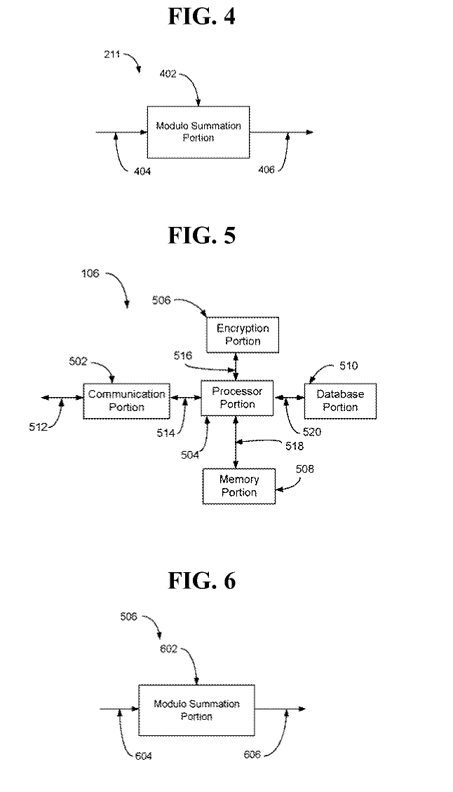

FIG. 4 illustrates an example decryption portion 211 of FIG. 2, in accordance with aspects of the present invention.

As illustrated in FIG. 4, Decryption portion 211 includes a modulo summation portion 402. Modulo summation portion 402 may receive information provided external to decryption portion 211 via a communication channel 404. Modulo summation portion 402 may transmit information externally to decryption portion 211 via a communication channel 406. Communication channel 404 and 406 are illustrated as distinct communication channels, they all may share a predetermined frequency band within a wireless medium.

Modulo summation portion 402 may decrypt a return vector transmitted by a server database by summing the vectors modulo 2. For example, summing the return vectors {0 1 0 1}, {0 1 1 0}, {1 1 1 0} and {0 1 0 0} by modulo 2 results in the vector {1 0 0 1}.

FIG. 5 illustrates an example database processor 106 of FIG. 1, in accordance with aspects of the present invention.

As illustrated in FIG. 5, Database processor 106 includes a communication portion 502, a processor portion 504, an encryption portion 506, a memory portion 508 and a database portion 510. All of communication portion 502, processor portion 504, encryption portion 506, memory portion 508 and database portion 510 are illustrated as individual devices. However, in some embodiments, at least two of communication portion 502, processor portion 504, encryption portion 506, memory portion 508 and database portion 510 may be combined as a unitary device. Further, in some embodiments, at least one of communication portion 502, processor portion 504, encryption portion 506, memory portion 508 and database portion 510 may be implemented as computer-readable media for carrying or having computer-executable instructions or data structures stored thereon.

Communication portion 502 may receive information from an external entity or entities via a communication channel 512. Processor portion 504 may communicate bi-directionally with communication portion 502 via a communication channel 514, with encryption portion 506 via a communication channel 516, with memory portion 508 via a communication channel 518 and with database portion 510 via a communication channel 520. Communication channel 512, 514, 516, 518 and 520 are illustrated as distinct communication channels, they all may share a predetermined frequency band within a wireless medium.

Communication portion 502 may communicate bi-directionally with external entities. Non-limiting examples of networks which communication portion 502 may communicate with include Ethernet, optical fiber, Local Area Network (LAN), Wireless LAN (WLAN), Internet, cable, cellular, satellite and power line.

Processor portion 504 may execute operational codes retrieved from memory portion 508 and to store and retrieve information to/from memory portion 508. Non-limiting examples of memory include Random Access Memory (RAM), Dynamic Random Access Memory (DRAM), Read-Only Memory (ROM), Digital Video Disk (DVD), Compact Disk Read-Only Memory (CDROM), Hard Disk (HD) and flash memory. Non-limiting examples of software languages for which operational codes for processor 206 may be compiled and assembled from include “C”, “C++”, “C#” and Java.

Encryption portion 506 may encrypt information for transmission to an external entity or entities via communication portion 502.

Database portion 510 may store and retrieve information. Information stored in database portion 510 may be viewed in matrix form with rows or records of information.

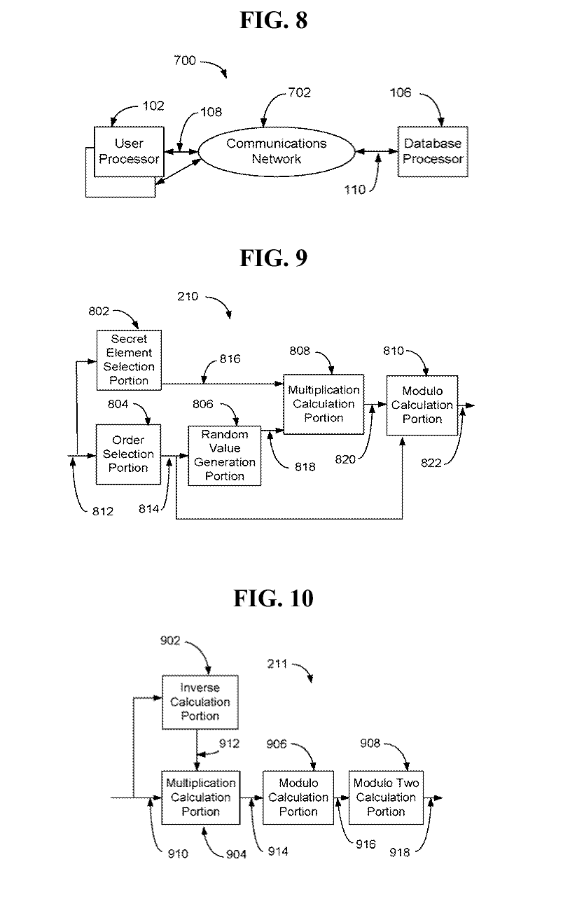

FIG. 6 illustrates an example encryption portion 506 of FIG. 5, in accordance with aspects of the present invention.

As illustrated in FIG. 6, Encryption portion 506 includes a modulo summation portion 602. Modulo summation portion 602 may receive information from an external entity or entities via a communication channel 604 and may transmit information to an external entity or entities via a communication channel 606. Communication channel 604 and 606 are illustrated as distinct communication channels, they all may share a predetermined frequency band within a wireless medium.

Modulo summation portion 602 may perform matrix multiplication of received encrypted vectors with information received from a server database. For example, for a server database as illustrated by:

$$DB = ( \begin{matrix}1 & 0 & 1 & 0 \\ 0 & 1 & 0 & 1 \\ 1 & 0 & 0 & 1 \\ 1 & 1 & 0 & 1\end{matrix} )$$

and vectors B₁ρU₁, D₁, D₂ and Dw for multiplication as discussed previously a return vector may be generated as illustrated by {0 1 1 0}, {0 1 0 1}, {0 1 0 0} and {1 1 1 0}.

Using the example server database, a simple explanation of an anonymity based cPIR protocol will now be provided.

Returning to FIG. 1, for purposes of discussion, presume user processor 102 wants to obtain the data from the third row of database processor 106. Further, for purposes of discussion, presume database processor 106 includes the matrix of data corresponding to DB above. To maintain anonymity, user processor 102 could not just send an inquiry indicating that it would like the data from the third row, e.g., sending a vector {0 1 0 0}. This is were the anonymity based cPIR protocol in accordance with aspects of the present invention resides.

Returning to FIG. 3, row vector generator portion 302 generates the vector corresponding to the row that user processor 102 wants to obtain from database processor 106. Random vector generator portion 304 generates three random vectors U₁, D₁ and D₂. In this example, for purposes of explanation, let U₁ be {1 1 0 0}, let D₁ be {0 1 0 0} and let D₂ be {0 0 1 1}.

Dw vector calculator portion then generates a vector D_{w} such that D_{w}+D₁+D₂=U₁. In this example, D_{w} would then be {1 0 1 1}.

XOR portion 302 then performs and exclusive OR operation on B₁ and U₁. The value of B₁, {0 1 0 0} in this example, was generated by row vector generator portion 302. The value of U₁, {1 1 0 0} in this example, was randomly generated by random vector generator portion 304. As such, in this example, B₁ρU₁, would be {1 1 1 1}.

Subquery generator portion 310 then sends 4 subqueries: 1) B₁ρU₁, as supplied by XOR portion 306, and in this example is {1 1 1 1} 2) D₁, as supplied by random vector generator portion 304, and in this example is {0 1 0 0}; D₂, as supplied by random vector generator portion 304, and in this example is {0 0 1 1}; and D_{w}, as supplied by Dw vector calculator portion 308, and in this example is {1 0 1 1}.

Database processor 106 receives each subquery and performs a matrix multiplication on the matrix of data DB. The result of each matrix multiplication is returned to user processor 102 as a response vector. In this example: the response vector for the first subquery {1 1 1 1} (which unbeknownst to database processor 106 has B₁ therein) is {0 1 1 0}; the response vector for the second subquery {0 1 0 0} (which unbeknownst to database processor 106 was randomly generated) is {0 1 0 1}; the response vector for the third subquery {0 0 1 1} (which unbeknownst to database processor 106 was also randomly generated) is {0 1 0 0}; and the response vector for the fourth subquery {1 0 1 1} (which unbeknownst to database processor 106 was calculated based on three other randomly generated vectors) is {1 1 1 0}.

Returning to FIG. 2, decryption portion 211 can now sum (mod 2) the response vectors to obtain the desired row of data from DB.

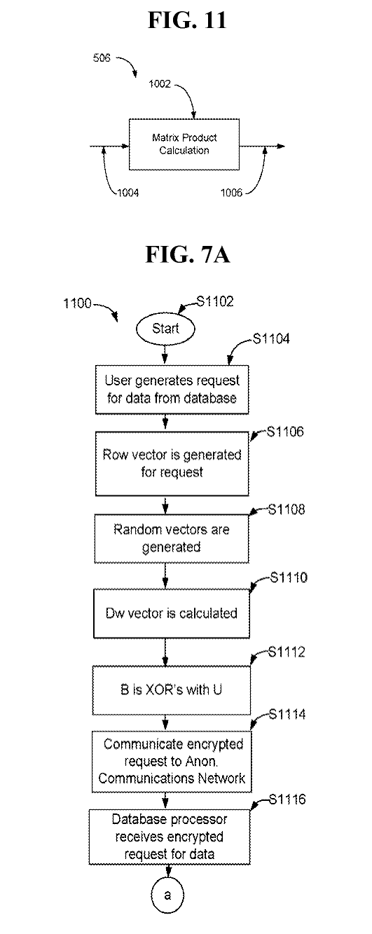

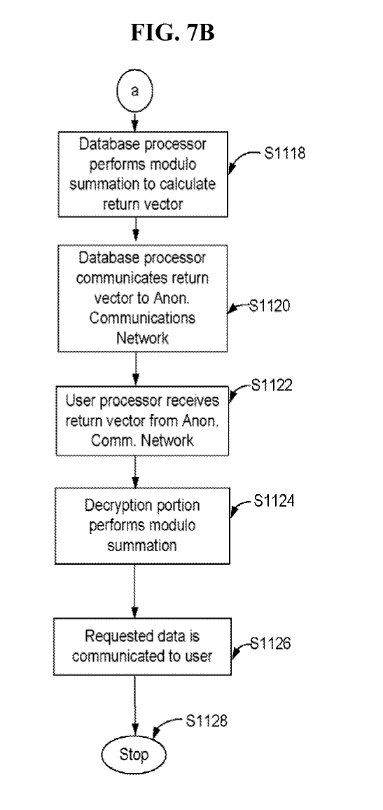

FIGS. 7A-B illustrate a more detailed example anonymity based cPIR protocol 700 for privately retrieving information in accordance with an aspect of the present invention.

Starting with FIG. 7A and with additional reference to FIG. 2, anonymity based cPIR protocol 700 starts (S702) and a user (not shown) may view information as presented by data output 208 of user processor 102 and may enter and communicate selections to user processor 102 via data input 204 (S704).

In an example embodiment, with additional reference to FIGS. 1 and 5, user processor 102 may request information supplied by user via data input 204 from database portion 510 via communication channel 108, anonymizing communications network 104 and communications network 110. Request for data by user may be received by processor 206 and communicated to encryption portion 210.

With reference to FIG. 3, a row vector may be generated by row vector generator portion 302 corresponding to the information requested by the user (S706).

For example, if a user seeks to obtain data located in the third row or record of the server database, then the third element of the vector generated by row vector generator portion 302 would be an integer 1 with all other elements of the vector configured as an integer 0. For example, for a server database with four rows or records, if a user is seeking information stored within the third row or record of the server database, then row vector generator portion 302 may generate a target vector as illustrated by B₁={0 0 1 0}.

Random vectors may then be generated (S708). In an example embodiment, random vector generator portion 304 may generate a set of random uniform vectors. For purposes of explanation, presume that the generated random uniform vectors include U₁={1 1 0 0}, D₁={0 1 0 0} and D₂={0 0 1 1}.

A Dw vector is then generated (S710). In an example embodiment, Dw vector calculator portion 308 may receive a portion of the random vectors generated by random vector generator portion 304 and computes a Dw vector.

Dw vector calculator portion 308 may generate a vector such that its summation with all Dᵢ vectors is equal to U₁, as illustrated by the equation Σᵢ₌₁^{w} Dᵢ=U. For example, for the previously discussed vectors D₁, D₂ and U₁, Dw may be calculated as {1 0 1 1}.

AN XOR operation is then performed (S712). In an example embodiment, XOR portion 306 may receive row vector from row vector generator portion 302 and a random vector from random vector generator portion 304 and perform an exclusive-or calculation for the received vectors. For purposes of discussion, presume XOR portion 306 performs an XOR of target vector B₁ and vector D₁, as discussed above and as illustrated by B₁ρU₁ or {0 0 1 0}ρ{1 1 0 0}. In such a case, the result would be vector {1 1 1 0}.

Subquery generator portion 310 may receive the results of the exclusive-or operation performed by XOR portion 306, random vectors generated by random vector generator portion 304 and the Dw vector computed by Dw vector calculator portion 308 and transfer the encrypted information request via subquery generator portion 310 to anonymizing communications network 104 by way of processor 206 and communication portion 202 (S714).

For example, subquery generator portion 310 may assemble a vector using the previously discussed target vector B, vector U and vector D vectors as B₁ ρU₁, D₁, D₂ and Dw.

Database processor 106 may then receive the encrypted data request (S716). In an example embodiment, the encrypted data requested may be communicated to database processor 106 by way of communication channel 108, anonymizing communications network 104 and communications network 110.

Transitioning to FIG. 7B, encryption portion 506 may then receive the encrypted request (S718). In an example embodiment, encryption portion 506 may receive the encrypted request by way of communication channel 512, communication portion 502, communication channel 514, processor portion 504 and communication channel 516. Encryption portion 506 may then perform modulo summation for the received encrypted request via modulo summation portion 602. For example, for purposes of explanation, presume a server database is illustrated by:

$$DB = ( \begin{matrix}1 & 0 & 1 & 0 \\ 0 & 1 & 0 & 1 \\ 1 & 0 & 0 & 1 \\ 1 & 1 & 0 & 1\end{matrix} )$$

and vectors B₁ρU₁, D₁, D₂ and Dw for multiplication, as discussed previously, a return vector may be generated as illustrated by {0 1 1 0}, {0 1 0 1}, {0 1 0 0} and {1 1 1 0}.

The calculated vector is then returned (S720). In an example embodiment, encryption portion 506 may return calculated vector to anonymizing communications network 104. For example, the calculated vector may be communicated to anonymizing communications network 104 by way of communication channel 606, communication channel 516, processor portion 504, communication channel 514, communication portion 502, communication channel 512 and communication channel 110.

The return vector is then received (S722). In an example embodiment, user processor 102 may receive calculated return vector from anonymizing communications network 104 via communication channel 108.

A modulo summation is then performed (S724). In an example embodiment, calculated return vector may then be received by decryption portion 211. For example, calculated return vector may be received by decryption portion 211 by way of communication channel 214, communication portion 202, communication channel 216, processor 206, communication channel 224, memory 212 and communication channel 223. Furthermore, modulo summation portion 402 of decryption portion 211 may perform a modulo summation calculation for the return vector. For purposes of discussion, presume in this example that modulo summation portion 402 sums the return vectors {0 1 0 1}, {0 1 1 0}, {1 1 1 0} and {0 1 0 0} by modulo 2, resulting in the vector {1 0 0 1}.

Decrypted data may then be communicated to user (S726). In an example embodiment, decrypted data may be communicated to user by way of communication channel 223, processor 206, communication channel 220 and data output 208.

Lastly, anonymity based cPIR protocol 700 stops (S728).

With the above discussed anonymity based cPIR protocol, given sender anonymity, a user mixes a small number of subqueries with other subqueries before sending to the server database. By mixing the subqueries, the adversary must guess the right subqueries to add back together to obtain the original query. This protocol provides better performance (both computational and communication costs) than the trivial protocol, yet maintains privacy.

A trapdoor group cPIR protocol in accordance with aspects of the present invention will now be described with reference to FIGS. 8-14.

FIG. 8 illustrates another example communication system 800 in accordance with aspects of the present invention.

As illustrated in the figure, communication system 800 includes a multiplicity of user processors with a sampling denoted as user processor 102, a communications network 802 and database processor 106.

User processor 102 and database processor 106 were discussed previously with respect to FIG. 1 and will not be discussed in detail with reference to FIG. 8.

Communications network 802 may communicate bi-directionally with user processor via communication channel 108 and with database processor 106 via communication channel 110. Communication channel 108 and 110 are illustrated as distinct communication channels, they all may share a predetermined frequency band within a wireless medium.

Communications network 802 may communicate information from various user processors and other network and network terminal devices. Communications network 802 may communicate with a plurality of communication capable devices. Non-limiting examples of networks which Communications network 802 may communicate with include Ethernet, optical fiber, Local Area Network (LAN), Wireless LAN (WLAN), Internet, cable, cellular, satellite and power line.

FIG. 9 illustrates another example of encryption portion 210 of FIG. 2, in accordance with aspects of the present invention.

As illustrated in FIG. 9, encryption portion 210 includes a secret element selection portion 902, an order selection portion 904, a random value generation portion 906, a multiplication calculation portion 908 and a modulo calculation portion 910. All of secret element selection portion 902, order selection portion 904, random value generation portion 906, multiplication calculation portion 908 and modulo calculation portion 910 are illustrated as individual devices. However, in some embodiments, at least two of secret element selection portion 902, order selection portion 904, random value generation portion 906, multiplication calculation portion 908 and modulo calculation portion 910 may be combined as a unitary device. Further, in some embodiments, at least one of secret element selection portion 902, order selection portion 904, random value generation portion 906, multiplication calculation portion 908 and modulo calculation portion 910 may be implemented as computer-readable media for carrying or having computer-executable instructions or data structures stored thereon.

Secret element selection portion 902 and order selection portion 904 may receive information from an external entity or entities via a communication channel 912. Random value generation portion 906 may receive information from order selection portion 904 via a communication channel 914. Multiplication calculation portion 908 may receive information from secret element selection portion 902 via a communication channel 916 and from random value generation portion 906 via a communication channel 918. Modulo calculation portion 910 may receive information from multiplication calculation portion 908 via a communication channel 920 and from order selection portion 904 via communication channel 914 and communicate information to an external entity or entities via a communication channel 922. Communication channel 912, 914, 916, 918, 920 and 922 are illustrated as distinct communication channels, they all may share a predetermined frequency band within a wireless medium.

Secret element selection portion 902 may generate a random secret element having a multiplicative inverse. An example for random secret element may be 33.

Order selection portion 904 may generate a group order which may not be required to be a prime number. An example for group order may be 83.

Random value generation portion 906 may generate random values such that a value selected may be less than the group order divided by 3. The value of the desired row of data to be retrieved from a server database determines whether a random value may be odd or even. For example, to retrieve the third row of a server database would result in the first two random values generated by random value generation portion 906 to be even and the third random value generated to be odd. For example, a set of random values may be 22, 12 and 23 which represents requesting the third row of data from a server database.

Multiplication calculation portion 908 may multiply secret element received from secret element selection portion 902 via communication channel 916 with random values received from random value generation portion 906 via communication channel 918. For example, the multiplication of 33(22), 33(12) and 33(23) may be performed to generate 726, 396 and 759.

Modulo calculation portion 910 may perform a modulo calculation for values received from multiplication calculation portion 908 via communication channel 920 and the group order selection received from order selection portion 904 via communication channel 914. For example, the modulo calculation of 726 mod 83, 396, mod 83 and 759 mod 83 may be performed to generate a return vector of 62, 64 and 12. Furthermore, modulo calculation portion 910 may communicate the calculated return vector external to encryption portion 210 via communication channel 922.

FIG. 10 illustrates another example of decryption portion 211 of FIG. 2, in accordance with aspects of the present invention.

As illustrated in FIG. 10, decryption portion 211 includes an inverse calculation portion 1002, a multiplication calculation portion 1004, a modulo calculation portion 1006 and a modulo two calculation portion 1008. All of inverse calculation portion 1002, multiplication calculation portion 1004, modulo calculation portion 1006 and modulo two calculation portion 1008 are illustrated as individual devices. However, in some embodiments, at least two of inverse calculation portion 1002, multiplication calculation portion 1004, modulo calculation portion 1006 and modulo two calculation portion 1008 may be combined as a unitary device. Further, in some embodiments, at least one of inverse calculation portion 1002, multiplication calculation portion 1004, modulo calculation portion 1006 and modulo two calculation portion 1008 may be implemented as computer-readable media for carrying or having computer-executable instructions or data structures stored thereon.

Inverse calculation portion 1002 may receive information from an external entity or entities via a communication channel 1010. Multiplication calculation portion 1004 may receive information from inverse calculation portion 1002 via a communication channel 1012 and may receive information from an external entity or entities via communication channel 1010. Modulo calculation portion 1006 may receive information from multiplication calculation portion 1004 via a communication channel 1014. Modulo two calculation portion 1008 may receive information from modulo calculation portion 1006 via a communication channel 1016 and communicate information to an external entity or entities via a communication channel 1018. Communication channels 1010, 1012, 1014, 1016 and 1018 are illustrated as distinct communication channels, they all may share a predetermined frequency band within a wireless medium.

Inverse calculation portion 1002 may compute an inverse of random secret element. The Euclidean algorithm may be used to perform the inverse calculation. For example, an inverse calculation for a random secret element of 33 as performed by the Euclidean algorithm would be 78.

Multiplication calculation portion 1004 may multiply a return vector received via communication channel 1010 with the inverse of random secret element received from inverse calculation portion 1002 via communication channel 1012. For example, the multiplication of 78(74), 78(86) and 78(43) may generate 5772, 6708 and 3354, respectively.

Modulo calculation portion 1006 may perform a modulo calculation of the multiplied return vectors received from multiplication calculation portion 1004 via communication channel 1014 with group order. For example, the modulo calculation of 5772 mod 83, 6708 mod 83 and 3354 mod 83 may be performed to generate 45, 35 and 34, respectively.

Modulo two calculation portion 1008 may perform a modulo two calculation for values received from modulo calculation portion 1006 via communication channel 1016. For example, the modulo calculation of 45 mod 2, 35, mod 2 and 34 mod 2 may be performed to generate 1, 1, 0, respectively. The information generated by modulo two calculation portion 1008 may be communicated to an external entity or entities via communication channel 1018.

FIG. 11 illustrates another example encryption portion 506 of FIG. 5, in accordance with aspects of the present invention.

As illustrated in FIG. 11, encryption portion 506 includes a matrix product calculation portion 1102. Matrix product calculation portion 1102 may receive information from an external entity or entities via a communication channel 1104 and transmit information to an external entity or entities via a communication channel 1106. Communication channel 1104 and 1106 are illustrated as distinct communication channels, they all may share a predetermined frequency band within a wireless medium.

Matrix product calculation portion 1102 may perform a matrix product calculation of a vector received via communication channel 1104 with a matrix of representation of information received from a server database. For example, the matrix product:

$$[ \begin{matrix}62 & 64 & 12\end{matrix} ] ( \begin{matrix}1 & 0 & 1 \\ 0 & 1 & 1 \\ 1 & 1 & 0\end{matrix} )$$

may be calculated by matrix product calculation portion 1102 as {74 76 126}. The response vector, in this example {74 76 and 126} is returned to user processor 102.

At this point, decryption portion 211 computes the values mod(secret number), wherein the secret number was provided by secret element selection portion 802, and in this example is 83. Decryption portion additionally divides the mod(83) values by b, wherein in this example b is 33. Thus, user processor 102 obtains:
78(74)/54 mod 83
78(76)/35 mod 83
78(43)/34 mod 83.

In other words, the product of 78(74) can be divided by 83 and have a remainder of 54. Similarly, the product of 78(76) can be divided by 83 and have a remainder of 35. Finally, the product of 78(43) can be divided by 83 and have a remainder of 34.

The parity of the calculated elements provides the data within the third row of DB at database processor 106 as:
45 mod 2=1
35 mod 2=1
34 mod 2=0.

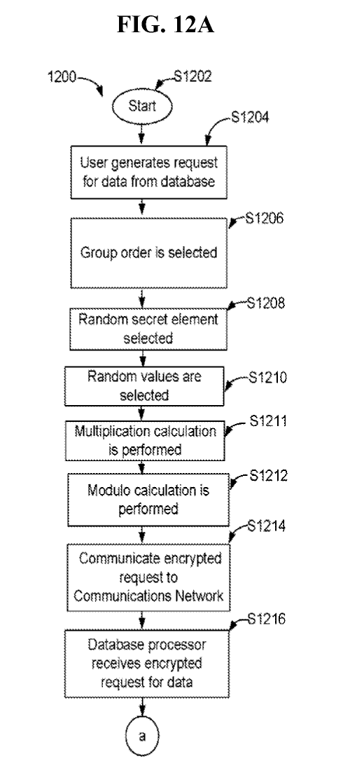

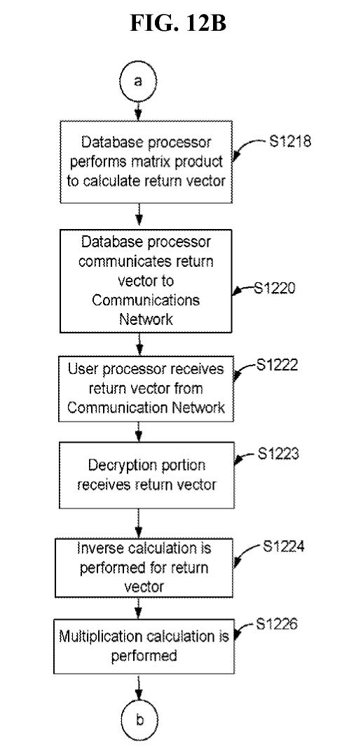

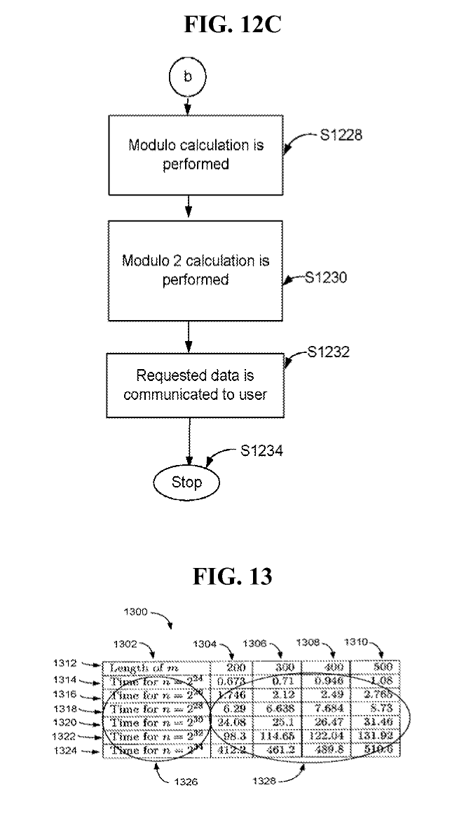

FIGS. 12A-C illustrate a more detailed example trapdoor group cPIR protocol 1200 for privately retrieving information in accordance with an aspect of the present invention.

Starting with FIG. 12A, trapdoor group cPIR protocol 1200 starts (S1202) and a user (not shown) requests data from a server database (S1204). For example, user operate to view information, as presented by data output 208 of user processor 102, and enter and communicate selections to user processor 102 via data input 204. User processor 102 may then request information supplied by user via data input 204 from database portion 510 via communication channel 108, anonymizing communications network 104 and communications network 110. Request for data by user may be received by processor 206 and communicated to encryption portion 210.

A group order is then selected (S1206). In an example embodiment, order selection portion 904 may receive data request via communication channel 912 and perform group order selection. Order selection portion 904 may generate a group order, which may not be required to be a prime number. For purposes of discussion, in this example, presume the group order is 83.

A random secret element is then selected (S1208). In an example embodiment, secret element selection portion 902 may receive data request via communication channel 912 and generate a secret random element. Secret element selection portion 902 may generate a random secret element having a multiplicative inverse. For purposes of discussion, in this example, presume the random secret element is 33.

Random values are then selected (S1210). In an example embodiment, random value generation portion 906 may receive group order selection from order selection portion 904 and generate random values such that the random values are less than the group order selection divided by 3. The value of the desired row of data to be retrieved from a server database determines whether a random value may be odd or even. For example, to retrieve the third row of a server database would result in the first two random values generated by random value generation portion 906 to be even and the third random value generated to be odd. For purposes of discussion, in this example, presume a set of random values are 22, 12 and 23, which represents requesting the third row of data from a server database.

A multiplication operation is then performed (S1211). In an example embodiment, multiplication calculation portion 908 receives the secret element from secret element selection portion 902 via communication channel 916 and receives the random values generated by random value generation portion 906 via communication channel 918. Multiplication calculation portion 908 then performs a multiplication operation of the secret element with the random values. For purposes of discussion, in this example, presume the multiplication of 33(22), 33(12) and 33(23) is performed to generate values 726, 396 and 759.

A modulo calculation operation is then performed (S1212). In an example embodiment, modulo calculation portion 910 receives the multiplication calculation values from multiplication calculation portion 908 via communication channel 920 and the group order selection from order selection portion 904 via communication channel 914. Modulo calculation portion 910 then performs a modulo calculation of multiplication values received from multiplication calculation portion 908 with group order selection received from order selection portion 904 to generate an encrypted request. For purposes of discussion, in this example, presume the modulo calculation of 726 mod 83, 396, mod 83 and 759 mod 83 is performed to generate a return vector of 62, 64 and 12.

The encrypted request is then communicated to the communications network (S1214). In an example embodiment, the encrypted request may be communicated from modulo calculation portion 910 to communications network 802 by way of communication channel 922, communication channel 222, processor 206, communication channel 216, communication portion 202, communication channel 214 and communication channel 108.

The server database then receives the encrypted request (S1216). In an example embodiment, database processor 106 receives the encrypted request from communications network 802 via communication channel 110.

Transitioning to FIG. 12B, the return vector is then calculated (S1218). In an example embodiment, modulo summation portion 602 receives the encrypted request by way of communication channel 512, communication portion 502, communication channel 514, communication channel 518, memory portion 508, communication channel 516 and communication channel 604. Modulo summation portion 602 then performs a matrix product calculation of the received encrypted request with data received from database portion 510 to generate return vector.

The calculated return vector is then sent to the communications network (S1220). In an example embodiment, modulo summation portion 602 communicates the calculated return vector to communications network 802 by way of communication channel 606, communication channel 516, processor portion 504, communication channel 514, communication portion 502, communication channel 512 and communication channel 110.

At this point, the user receives the return vector (S1222). In an example embodiment, user processor 102 receives the return vector from communications network 802 via communication channel 108.

Decryption portion 211 then receives the return vector (S1223). In an example embodiment, decryption portion 211 receives the return vector by way of communication channel 214, communication portion 202, communication channel 216, processor 206, communication channel 224, memory 212 and communication channel 223.

Then an inverse calculation is performed (S1224). In an example embodiment, inverse calculation portion 1002 receives notice of receiving return vector via communication channel 1010 and generates an inverse of the secret random element. The Euclidean algorithm may be used to perform the inverse calculation. For purposes of discussion, in this example, presume an inverse calculation for a random secret element of 33 as performed by the Euclidean algorithm would be 78.

At this point, a multiplication operation is performed (S1226). In an example embodiment, multiplication calculation portion 1004 receives the return vector information via communication channel 1010 and the inverse secret random element via communication channel 1012. Multiplication calculation portion 1004 performs a multiplication of the inverse secret random element with the return vector information. For purposes of discussion, in this example, presume multiplication calculation portion 1004 performs the multiplication of 78(74), 78(86) and 78(43) so as to generate the values 5772, 6708 and 3354, respectively.

Transitioning to FIG. 12C, a modulo calculation is then performed (S1228). In an example embodiment, modulo calculation portion 1006 receives the multiplication values from multiplication calculation portion 1004 via communication channel 1014 and perform a modulo calculation of the multiplication values with the group order selection value. For purposes of discussion, in this example, presume the modulo calculation of 5772 mod 83, 6708 mod 83 and 3354 mod 83 is performed to generate the values 45, 35 and 34, respectively.

A modulo calculation is then performed (S1230). In an example embodiment, modulo two calculation portion 1008 receives the modulo calculation values from modulo calculation portion 1006 via communication channel 1016 and perform a modulo two calculation on the received values to generate decrypted data. For purposes of discussion, in this example, presume the modulo calculation of 45 mod 2, 35 mod 2 and 34 mod 2 is performed to generate the values 1, 1, 0, respectively.

Decrypted data is then presented to the user (S1232). In an example embodiment, encrypted data is presented to user via communication channel 1016, communication channel 223, processor 206, communication channel 220 and data output 208.

Lastly, trapdoor group cPIR protocol 1200 stops (S1234).

With the trapdoor group cPIR protocol discussed above, an inversion problem such as computing discrete logarithms may be computed efficiently assuming knowledge of the trapdoor. Without the trapdoor, solving the inversion problem is computationally hard. Accordingly, this protocol additionally provides better performance (both computational and communication costs) than the trivial protocol, yet maintains privacy.

FIG. 13 presents a table 1300 of execution times for a trapdoor group cPIR protocol in accordance with aspects of the present invention.

As illustrated in the figure, a table 1300 includes a column 1302, a column 1304, a column 1306, a column 1308, a column 1310, a row 1312, a row 1314, a row 1316, a row 1318, a row 1320, a row 1322 and a row 1324.

Row 1312 illustrates header information for length of variable m, where variable m represents all the integers smaller than m bits. A table area 1326 represents various values for variable n, where variable n represents the size of a server database. A table area 1328 illustrates various execution times for securely retrieving information for a group size of variable m from a server database size of variable n. As illustrated by table 1300, an increase in group size or an increase in server database size translates into an increase in time for securely retrieving information from a server database, as expected.

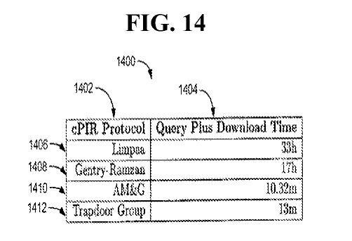

FIG. 14 presents a table 1400 of execution times for a trapdoor group cPIR protocol in accordance with aspects of the present invention as compared to prior art implementations.

As illustrated in the figure, table 1400 includes a column 1402, a column 1404, a row 1406, a row 1408, a row 1410 and a row 1412.

Column 1402 illustrates the implementation of a trapdoor group cPIR protocol for securely retrieving information from a server database in accordance with the present invention. Column 1404 illustrates the execution time for securely retrieving information from a server database for a protocol as denoted in column 1402. Row 1406, 1408 and 1410 illustrate execution times for prior protocol implementations. Row 1412 illustrates execution times for the present invention as illustrated in FIGS. 2, 5, 7-10.

The execution time as illustrated for the exemplary embodiment of the present invention as illustrated by row 1412 is comparable to the prior execution time as illustrated by row 1410 and is significantly faster than the prior execution times as illustrated by row 1406 and row 1408. The comparisons as illustrated in Table 1400 are a rough comparison, as the machine used for secure information retrieval for the exemplary embodiment of the present invention was different from the machines used for prior art implementations.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a database server having a matrix of data stored therein and being able to transmit a return vector based on the matrix of data, said device comprising:
a communication portion;
an encryption portion operable to generate an encrypted request to obtain a portion of the matrix of data, the encrypted request including a plurality of subqueries; and
a decryption portion,
wherein said communication portion is operable to transmit the encrypted request to the database server and to receive the return vector from the database server,
wherein one of the subqueries is based on a first random vector and a target vector corresponding to the portion of the matrix of data,
wherein one of the subqueries is based on a second random vector, and
wherein said decryption portion is operable to decrypt the return vector by way of a modulo summation.

2. The device of claim 1,
wherein said encryption portion includes a row vector generator portion, a random vector generator portion, an XOR portion and a subquery generator portion,
wherein said row vector generator portion is operable to generate the target vector,
wherein said random vector generator portion is operable to generate the first random vector,
wherein said XOR portion is operable to provide an XOR output based on an XOR operation with the target vector and the first random vector, and
wherein said subquery generator portion is operable to generate the plurality of subqueries based on the XOR output.

3. The device of claim 2, wherein said random vector generator portion is operable to generate the second random vector.

4. The device of claim 3, wherein said random vector generator portion is operable to generate a third random vector.

5. The device of claim 4, wherein said encryption portion further includes a Dw vector calculation portion operable to generate a fourth vector, such that the sum of the second random vector, the third random vector and the fourth vector equals the first random vector.

6. The device of claim 5,
wherein said subquery generator portion is operable to generate the plurality of subqueries as a first subquery, a second subquery, a third subquery and a fourth subquery,
wherein the first subquery includes the XOR output,
wherein the second subquery includes the second random vector,
wherein the third subquery includes the third random vector, and
wherein the fourth subquery includes the fourth vector.

7. A method of obtaining a portion of data from a database server having a matrix of data stored therein, the database being able to transmit a return vector based on the matrix of data, said method comprising:
generating, via an encryption portion, an encrypted request to obtain a portion of the matrix of data, the encrypted request being based on a group order number m and a secret number b; and
transmitting, via a communication portion, the encrypted request to the database server;
receiving, via the communication portion, the return vector from the database server, and
decrypting, via a decryption portion, the return vector by way of performing a combination of a modulo m operation on the return vector to obtain a quotient vector and by dividing the quotient vector by a secret number b.

8. The method of claim 7, wherein said decrypting, via a decryption portion, the return vector by way of performing a combination of a modulo m operation on the return vector to obtain a quotient vector and by dividing the quotient vector by a secret number b comprises:
generating, via a multiplication calculation portion, generate the target vector:
generating, via a random vector generator portion, a multiplied vector based on a product of the secret number b a vector of secret coefficients; and
generating, via a modulo calculation portion, by performing a modulo calculation based on the multiplied vector and the group order number m.

9. A computer-readable media having computer-readable instructions stored thereon, the computer-readable instructions being capable of being read by a computer to obtain a portion of data from a database server having a matrix of data stored therein, the database being able to transmit a return vector based on the matrix of data, the computer-readable instructions being capable of instructing the computer to perform the method comprising:
generating, via an encryption portion, an encrypted request to obtain a portion of the matrix of data, the encrypted request being based on a group order number m and a secret number b; and
transmitting, via a communication portion, the encrypted request to the database server;
receiving, via the communication portion, the return vector from the database server, and
decrypting, via a decryption portion, the return vector by way of performing a combination of a modulo m operation on the return vector to obtain a quotient vector and by dividing the quotient vector by a secret number b.

10. The computer-readable media of claim 9, the computer-readable instructions being capable of instructing the computer to perform said decrypting, via a decryption portion, the return vector by way of performing a combination of a modulo m operation on the return vector to obtain a quotient vector and by dividing the quotient vector by a secret number b further comprising computer-readable instructions being capable of instructing the computer to:
generate, via a multiplication calculation portion, generate the target vector:
generate, via a random vector generator portion, a multiplied vector based on a product of the secret number b a vector of secret coefficients; and
generate, via a modulo calculation portion, by performing a modulo calculation based on the multiplied vector and the group order number m.
